(19) United States
(12) Patent Application Publication
(10) Pub. No.: US 2004/0013768 A1
(43) Pub. Date: Jan. 22, 2004

(54) Method of obtaining ethyl alcohol or aqueous-alcoholic solution for preparation of vodka

(76) Inventors: Robert G. Khatchatrian, Glendale, CA (US); Tigran Khatchatrian, Glendale, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 09/928,917

(22) Filed: Aug. 13, 2001

(51) Int. Cl. C12C 11/00

(52) U.S. Cl. 426/11

(57) ABSTRACT

The present application is related to the production of ethyl alcohol or an aqueous alcohol solution which may be used for preparation of vodka or other alcoholic beverages. The present invention also provides a method of processing of alcohol or vodka to neutralize the action of toxic substances.

### BACKGROUND OF THE INVENTION

1. Field of the Invention

The present application is related to the production of ethyl alcohol or an aqueous alcohol solution which may be used for preparation of vodka or other alcoholic beverages. The present invention also provides a method of processing of alcohol or vodka to neutralize the action of toxic substances.

2. Description of the Related Art

The related technology concerns the alcohol and liqueur industry, in particular the industrial manufacture of alcohol drinks, for instance, vodka or other alcohol beverages.

It is understood by those knowledgeable in this field that the common impurities found in ethanol and vodka and various liqueurs produced from ethanol, are highly-toxic compounds, such as fusel oils, methanol, acetaldehyde, which are formed in the production of ethyl alcohol. Use of the alcohol beverages containing these impurities, may result in the intoxication of an organism, in various forms of food poisoning and in gastrointestinal dysfunction. Additionally, the occurrence of a subjectively unpleasant psychophysical state on the day after use of alcohol in significant quantities is also known. This state is related to adverse effects on the water/electrolytic balance and intoxication by products derived from toxic compounds which may be found in alcohol. The state experienced after acute alcoholic intoxication is classified as post-intoxication syndrome. Purification of the spirit or liqueur products away from toxic substances, such as fusel oils and acetaldehyde, or neutralization of their activity, is critical.

Preparation of alcohol is a known process, including, for instance, purification of the alcohol, i.e. division of liquid mixtures to separate components or fractions, distinguished by their boiling temperatures. Column devices (Japanese Application No. 4-27830), are typically used in this purification. However, acetaldehyde and fusel oils have practically identical boiling temperatures in relation to the ethanol itself, and in order to separate these from ethanol separation significant technological expenses and complex equipment are required.

Methods of producing ethanol are known, including the crushing of raw materials containing starch and mixing it with water. Raw material which may be used include tubers of Helianthus tuberosus (U.S. Pat. No. 4,400,469; France Application No.2470796), batata (yam or sweet potato) (Japan Application No. 59-6639), sugar reed (U.S. Pat. No. 4,326,036), grain of millet, sorgo (sorghum) or raps (ripeseed) (Germany Application No. 3445049), and sugar beet (French Application No. 26106451). The mixture may be processed at a temperature of 100-150° C. within 30-60 minutes, saccharized (subjected to hydrolysis) using the malt enzymes of the soft-cooked mass, and fermented using yeast at temperatures of 23-25° C. in fermentors. The fermented mash is purified in the distillers to produce the raw spirit/alcohol. The raw spirit may then be subjected to purification in the column devices, as previously described. However, this process results in a product which is purified sufficiently from toxic compounds, including fusel oils and acetaldehyde.

Methods for producing vodka or other alcohol beverages which involve fermenting pre-pasteurized and cooled whey with Candida or Torulopsis yeast to form a mash containing ethanol and products of proteolysis are known, as are the processes of recovering the ethanol and products of proteolysis from the mash, purifying the ethanol from the products of proteolysis, and diluting the resultant purified ethanol with de-proteinized whey. This process makes it possible to replace scarce grain, potato and beet raw materials used to produce vodka (U.S. Pat. No. 4,086,366). In addition, replacement of cow milk whey as a starting material is economically efficient and of vital importance for human nutrition.

Methods of manufacturing alcohol-containing beverages using soybean milk (U.S. Pat. No. 4,656,044) and Go, removing okara, and adding ethanol to the resultant solution in the amount of 3-30% (U.S. Pat. No. 5,853,789) are known. The term “Go” used herein means a mixture which is obtained by grinding down soy beans, and includes liquid both with or without alcohol. The term “Okara” used herein refers to the solids generated after filtering Go. Removing the okara deprives the final product, the alcoholic beverage, of a unique vegetative source of ferrous iron, as well as vitamins A, B1, B2, and niacin, which are easily assimilated by an organism. This method does not allow for production of ethyl alcohol from the products of soybean pressing and grinding, okara, as only the soybean milk is used. In addition, the use of a chemical agent, high-methoxylpectin, in this process makes the process more expensive. Moreover, the addition of chemical agents to any food product is undesirable.

The production of ethanol from Jerusalem Artichokes (Helianthus tuberosus) (U.S. Pat. No. 4,400,469), includes removing the sugar juices before the sugar moves down into the tubers and fermenting the sugar to produce ethanol, thereby eliminating the necessity of converting the starch found in the tubers to fermentable sugars before fermenting the sugar to produce ethanol. However, this method utilizes only the sugar solution found inn the tubers in the manufacture of ethyl alcohol, but wastes the vegetative mass which remains after removing the juices. The production of ethanol from starch-containing tubers is complicated and costly, as well.

### SUMMARY OF THE INVENTION

The present invention provides the method of manufacture of ethyl alcohol and the purification of spirits or vodka by introduction of components which neutralize the action of toxic substances, contained in spirit or vodka. The method includes the crushing of starch-containing raw material, mixing it with activated water on a membranous electrolyser with a positive redox-potential (+900−+1200) mV and pH 1.02.0 and processing the mixture at a temperature of 100-120° C. for not less than 30 minutes, saccharizing (subjected to hydrolysis) of the soft-cooked mass using malt enzymes, fermentation of the received mash using the yeast at a temperature of 23-25° C. in the reactor, distillation of fermented mash to obtain a crude spirit (raw spirit): the first fraction of which is 80-83% spirit, the second fraction of which is 70-79% spirit and the third fraction of which is 40-59% spirit, and purification of fractions 1, 2 and 3 separately (in fractions) and a final product which contains 95-96% spirit. As a starch-containing raw material, soybeans, or okara (oilcake) which is produced from soybeans as the result of squeezing (pressing) of soy milk on a filter-press, were used. Before the mash fermentation, in which yeast is used, soy flour is entered in the ratio of not more than 10:1 by mass, the soy flour having been produced from germinated soybeans which were previously processed not less than 3 hours before germination by means of a growth stimulator. The growth stimulator is activated water, manufactured on a membranous electrolyser with negative redox-potential (−500−900)mV and pH 9.0-11.0. The soy flour is added in the amount of not less than 50% to the mass of soybeans. In the raw spirit of fractions 1, 2 and 3, prior to purification, the dry soy milk or dry dairy whey is added in the amount of 0.5-5.0 kg per 1000 liters spirit. Each fraction is mixed and maintained for at least 3 hours, with the subsequent filtration.

### DETAILED DESCRIPTION OF THE PREFERRED EMBODIMENT

The purpose of the invention described herein is to utilize all the components of a vegetable material in order to produce ethyl alcohol, which will later be used in the manufacture of high grade alcohol beverages (for instance, vodka) of the maximum quantity without increased expense.

The method includes the crushing of starch-containing raw material, mixing it with activated water on membranous electrolyser with positive redox-potential (−900−1200) mV and pH 1.0-2.0 and processing of the mixture at a temperature of 100-120° C. for at least 30 minutes, saccharizing (subjected to hydrolysis) of the soft-cooked mass using malt enzymes, fermentation of the mash using yeast at a temperature of 23-25° C. in the reactor, distillation of fermented mash for production of the crude spirit (raw spirit): the first fraction of which is 80-83% spirit, the second fraction of which 70-79% spirit and the third fraction of which is 40-59% spirit, and purification of fractions 1, 2 and 3 separately (in fractions) and finishing with a spirit which is 95-96% ethanol. As a starch-containing raw material we use soybeans, or okara (oilcake) which is produced from soybeans as the result of squeezing (pressing) of soy milk on a filter-press. Before the mash fermentation by yeast, the soy flour is added in the ratio of not more than 10:1 by mass, with the soy flour will being produced from germinated soybeans, previously processed during not less than 3 hours before germination by means of a growth stimulator. The growth stimulator uses activated water, manufactured on a membranous electrolyser with negative redox-potential (−500−900)mV and pH 9.0-11.0. The soy flour is added in the amount of not less than 50% to the mass of soybeans, and in the raw spirit of fractions 1, 2 and 3 before purification the dry soy milk or dry dairy whey is added in the amount of 0.5-5.0 kg per 1000 liters spirit. Each fraction is mixed and maintained for not less than 3 hours, with the subsequent filtration.

The starch-containing raw material intended for manufacture of ethyl alcohol is soybeans, or okara (oilcake), that is crushed and mixed with activated water, which has been manufactured on a membranous electrolyser with positive redox-potential (+900−+1200) mV and pH 1.0-2.0. The mixture is processed at a temperature of 100-120° C. for not less than 30 minutes, followed by saccharizing (hydrolysis) of the soft-cooked mass using the malt enzymes, fermentation of the resultant mash by yeast at a temperature of 23-25° C. in fermentators, distillation of the fermented mash for production of a crude spirit (raw spirit): the first fraction 80-83% of spirit, the second fraction 70-79% of spirit and the third fraction 40-59% of spirit. This is followed by purification of fractions 1, 2 and 3 separately with the finished spirit containing 95-96% alcohol.

The present invention seeks to provide a process that will purify the ethanol or vodka produced and neutralize the action of toxic substances, contained in spirit or vodka. This is achieved by using the raw material, soybeans or okara (oilcake), which is produced from soybeans as a result of squeezing and pressing soybeans to produce soy milk using a filter-press. Prior to fermentation the mash is added to soy flour in the ratio of no more than 10:1 by mass. The soy flour is produced from germinated soybeans, which before germination are processed by means of a growth stimulator for not less than 3 hours, and in which the water used was activated on a membranous electrolyser with negative redox-potential (−500−900) mV and pH 9.0-11.0. The growth stimulator is added in the amount of not less than 50% to the total mass of soybeans. To the crude spirit (raw spirit) fractions 1, 2 and 3, prior to purification the dry soy milk or dry cow milk whey is added in the amount of 0.5-5.0 kg per 1000 liters spirit. The mixture of each fraction will be mixed and maintained for not less than 3 hours and then filtered. Before fermentation of the mash the whey received from soy milk in the ratio of no more than 10:1 is additionally entered to the mash. The processing of soybeans before their germination using the activated solution accelerates the germination.

The germinated soybeans contain about 45% protein which contain all essential amino acids, 40% carbohydrates (starch and sugar), 11% lipids including linoleic and linolenic acids, and 3.5% nucleic acids (growth stimulators). The product contains the water-soluble (B₁, B₂, B₆, niacin, pantothenic acid, folic acid) and lipid-soluble (A and E) vitamins, as well as 21 mineral elements. The germ of soybeans provide antioxidant activity, due to vitamin E, and also improves the balance of mineral elements. Okara also contains the unique vegetative source of ferrous iron, which may be easily assimilated by an organism, in addition to vitamins A, B₁, B₂.

The present invention also includes the addition of bee's wax to the crude alcohol to bind acetaldehyde and fusel oils, that may then be easily removed from the product by filtration. The additives of the present invention are efficient in producing a purified spirit or vodka. The crude spirit of fractions 1, 2 and 3 are warmed to 60-70° C., and bee's wax, which is previously melted down at 60-70° C., is added to the crude (raw) spirit. The resultant mixture is mixed for not less than 30 minutes and cooled to room temperature with the subsequent removal of the hardened bee's wax and filtration of raw spirit of fractions 1, 2 and 3. Thus, the organoleptic properties of the spirit are increased and unpleasant smells are eliminated. Manufacture of an aqueous-alcoholic solution has been achieved by mixing ethyl spirit, produced by the methods described herein, with the water/salt solution activated on a membranous electrolyser with negative redox potential (−500−900) mV and pH 9.0-11.0 in an amount sufficient for obtaining a mixture of 40% alcohol. The electro-activated water/salt solutions used include a mixture of the salts NaCl, KCl, CaCl₂, MgCl₂ in the same ratio as that found in the blood plasma of a human, with the total concentration of salts being no more than 10 g/liter. This ratio of salts NaCl, KCl, CaCl₂, and MgCl₂ in the electro-activated water solution is 80:2:2:1, respectively.

The inventors research has established that in membranous electrolyser at a constant current transmission through a water solution, for example the water/salt solution, the electro-activation of molecules, atoms, ions, as well as the redistribution of ions in the electric field, occurs. As a result a portion of this water solution in the cathode zone (catolite) acquires some restorative properties and reserves the potential energy. The catolite with negative oxidation and restoring redox potential, in an interval from −400 to −900 mV and at pH 7.5-11.0 provides the greatest biological activity, due to increased intensity of electrochemical processes, for example in solutions, mixtures, and also in living cell systems. It accelerates all natural biological processes. The catolite has immunostimulating and detoxifying features, and it also normalizes the metabolism in an organism. The electro-activated water/salt solutions with positive redox-potential (+900−+1200) mV and pH 1.0-2.0 (anolite) intensify the processes of starch transformation to soluble sugar.

The successful combination of purifying alcohol away from fusel oils and aldehydes by means of vegetative proteins and bee's wax, in combination with the use of activated salt solutions at concentrations similar to those of salts in blood, promotes the physiological value of alcoholic beverages and their organoleptic properties.

### EXAMPLES

### Example 1

Crushed soybeans were mixed in the ratio 1:4 with water, which was activated on a membranous electrolyser with positive redox-potential +900 mV at pH 2.0. The resultant mixture was processed at a temperature of 120° C. for not less than 90 minutes. The mass was cooled to 57° C., and a barley malt was added in an amount of 10% by mass for saccharizing (hydrolysis) the soft-cooked mass by enzymes of the barley malt. The saccharized mash was cooled to 45° at pH 5.0. A soy flour produced from germinated soybeans is added to the mash in the ratio 10:1. The soybeans were previously processed for not less than 3 hours before germination using the growth stimulator (the water activated on membranous electrolyser with negative redox-potential −500 mV and pH 9.0). The activated water is added in an amount of not less than 50% to the mass of germinated soybeans. The growth stimulator accelerates the germination of soybeans in 17-20 hours. The flour of the germinated soybeans provides a good nutritious medium for yeast. It provides the fermentation intensity and allocation of CO₂. The fermentation itself begins in 2-3 hours earlier, which also accelerates a fermentation of mash.

An amount of 5-7 g of yeast per 1 liter of the sugar solution is added while intensive mixing for 10 minutes. The yeast mass in amount of 10% to the mash mass is added in the reactor, and the mixture is fermented at a temperature of 23-25° C. for 3 days. Thereafter, the mass is squeezed and filtered and then pumped into the special container. The mass is then fermented for 2 days, then the mash is distilled to produce the raw spirit (crude spirit): the first fraction of which is 80-83% spirit, the second fraction of which is 70-79% spirit, and the third fraction of which is 40-59% spirit.

In the raw spirit of fractions 1, 2, and 3, dry soy milk in the amount of 0.5 kg per 1000 liters spirit is added. Each fraction is mixed and maintained for not less than 3 hours, with the subsequent filtration. Further the spirits of fractions 1, 2, and 3 were separately purified, and the final spirit produced contains 95-96% alcohol.

### Example 2

Okara (oilcake) from soybeans, which results from squeezing and filtering soy milk, was mixed in the ratio 1:4 with water activated on membranous electrolyser with positive redox-potential +1200 mV at pH 1.0. The mixture is processed at a temperature of 100° C. for 60 minutes. The mass is cooled to 57°, and barley malt in the amount of 10% by mass for saccharizing (hydrolysis) of the soft-cooked malt is added. The saccharized mash is cooled to 45° C. at pH 5.0. The soy flour produced from germinated soybeans is added to the mash in a ratio of 10:1. Prior to germination, the soybeans were processed within not less than 3 hours by means of the growth stimulator, the water activated on membranous electrolyser with negative redox-potential −900 mV and pH 1.0. The activated water is added in the amount of not less than 50% to the soybeans' mass. The stimulator of growth accelerates the germination of soybeans in 17-20 hours. The flour of the germinated soybeans is a good nutritious medium for yeast. It provides intensity of fermentation and allocation of CO₂. The process of fermentation begins 2-3 hours earlier, and also accelerates the mash fermentation. Simultaneously the yeast is suspended in a 15% solution of saccharose (sucrose) in the amount of 5-7 g of yeast per 1 liter of sugar solution with intensive mixing within 10 minutes. The starch mixture in the amount of 10% of the total mass of the mash is added in the reactor, and the mixture is fermented at a temperature of 23-25° C. within 3 days. After fermentation the mass is filtered and pumped to the container for fermentation. Here the mass is fermented for 2 days, then the fermented mash is distilled to produce the raw spirit: the first fraction of which is 80-83% alcohol, the second fraction of which is 70-79% alcohol, and the third fraction of which is 40-59% alcohol.

In the raw alcohol of fractions 1, 2, and 3 dry cow milk whey in the amount of 5.0 kg per 1000 liters alcohol is added. The each fraction is then mixed and maintained for not less than 3 hours, with the subsequent filtration. Further the separate purification of fractions 1, 2, and 3 of alcohol is carried out, and the final product is 95-96% alcohol.

### Example 3

Okara (oilcake), which results from the squeezing and pressing of soybeans to produce soymilk was mixed in the ratio of 1:4 with water activated on a membranous electrolyser with positive redox-potential +1200 mV at pH 1.0. The mixture was processed at a temperature of 100° C. for 60 minutes. The mass was cooled to 57° C. and barley malt was added in the amount of 10% by mass for saccharizing (hydrolysis) of the soft-cooked mass by means of barley malt enzymes. The saccharized mash was cooled to 45° C. at pH 5.0, and soy flour produced from germinated soybeans was added in the ratio of 10:1. The soybeans were previously processed within not less than 3 hours before germination using the growth stimulator, the activated water with negative redox-potential −900 mV at pH 11.0. The activated water was added in the amount of not less than 50% by mass of soybeans to be germinated. The growth stimulator accelerates the germination of soybeans in 17-20 hours. The flour of germinated soybeans is a good nutritious medium for yeast. It provides intensity of fermentation and accelerates the malt fermentation. Additionally, before the mash fermentation, the soy milk whey was also added in the ratio of 10:1. Simultaneously the yeast was suspended in a 15% of saccharose solution with the amount of 5-7 g yeast per 1 liter of sugar solution with intensive mixing for 10 minutes. The yeast mixture, in the amount of 10% of the total mass of the mash, was added in the reactor, and the mixture was fermented at a temperature of 23-25° C. for 3 days. After the fermentation the mass was squeezed, filtered, and pumped to the fermentors, where the mass was fermented for 2 additional days. Then the fermented mash was distilled to produce a raw spirit: the first fraction of which was 80-83% spirit, the second fraction of which was 70-79% spirit and the third fraction of which was 40-59% spirit. The raw spirit of fractions 1, 2, and 3 were mixed with dry cow milk whey in the amount of 5.0 kg per 1000 liters of spirit. Each fraction was mixed and maintained for not less than 3 hours, with subsequent filtration. In addition, the raw spirit of fractions 1, 2, and 3 were warmed to 60-70° C., and bee's wax, after its melting at 60-70° C., was added. This was then mixed for not less than 30 minutes and cooled to room temperature, and the hardened particles of the bee's wax were removed. The spirit of fractions 1, 2 and 3 were filtered. Fractions 1, 2 and 3 of the spirit were purified separately (in fractions), and the spirit produced contained 95-96% alcohol.

### Example 4

To manufacture vodka, a solution was prepared by mixing ethyl alcohol produced according to Example 1 with water/salt solution, activated on membranous electrolyser with negative redox-potential −500 mV and pH 9.0 in an amount sufficient for production of a solution of 40% alcohol. A mixture of the salts NaCl, KCl, CaCl₂, and MgCl₂, in the same ratio as that found in the blood plasma of a human with total concentration of salts no more than 10 g/liter, was used as the electro-activated water/salt solution. The ratio of salts NaCl, KCl, CaCl₂, and MgCl₂ in the electro-activated water solution was 80:2:2:1, respectively.

### Example 5

To manufacture vodka, a solution was prepared by mixing the ethyl alcohol produced by the methods described in Example 2 with a water/salt solution, activated on a membranous electrolyser with negative redox-potential −700 mV and pH 10.0 in the amount sufficient for production of a solution of 40% alcohol. A mixture of the salts NaCl, KCl, CaCl₂, and MgCl₂, in the same ratio as that found in the blood plasma of a human with total concentration of salts no more than 10 g/liter, was used as the electro-activated water/salt solution. The ratio of salts NaCl, KCl, CaCl₂, and MgCl₂ in the electro-activated water solution was 80:2:2:1, respectively.

### Example 6

To manufacture vodka, a solution was prepared by mixing the ethyl alcohol produced by the methods described in Example 2 with a water/salt solution, activated on a membranous electrolyser with negative redox-potential −900 mV and pH 11.0 in the amount sufficient for production of a solution of 40% alcohol. A mixture of the salts NaCl, KCl, CaCl₂, and MgCl₂, in the same ratio as that found in the blood plasma of a human with total concentration of salts no more than 10 g/liter, was used as the electro-activated water/salt solution. The ratio of salts NaCl, KCl, CaCl₂, and MgCl₂ in the electro-activated water solution was 80:2:2:1, respectively.

What is claimed is:

1. A method of producing ethyl alcohol or an aqueous-alcoholic solution comprising;
crushing soybeans to produce starch-containing raw material;
squeezing said raw material to produce mash;
filtering the mash to obtain okara and soymilk;
fermenting the okara; and
distilling alcohol from the fermented okara.

2. The method of claim 1, additionally comprising adding bee's wax to the distilled alcohol to at least partially remove fusel oil therefrom.

3. The method of claim 1, wherein, prior to fermenting, the okara is mixed with water to create a mixture.

4. The method of claim 3, wherein the water is activated on a membranous electrolyser with a positive redox-potential (+900−+1200) mV at pH 1.0-2.0.

5. The method of claim 3, wherein the mixture is processed at a temperature of 100-120° C. for not less than 30 minutes to produce a soft-cooked mass.

6. The method of claim 4, wherein the soft-cooked mass is saccharized by enzymes from barley malt mash.

7. The method of claim 1, wherein soy flour produced from germinated soybeans, is added to the soybeans in a ratio in the range from about 1:10 to about 10:1 by mass.

8. The method of claim 1, wherein the mash is fermented using yeast at a temperature of 23-25° C. to produce a fermented mash.

9. The method of claim 7, wherein the fermented mash is distilled to obtain three fractions of raw alcohol (spirit): the first fraction comprising 80-83% spirit, the second fraction comprising 70-79% spirit and the third fraction comprising 40-59% spirit.

10. The method of claim 8, wherein purification of each of fractions 1, 2 and 3 is performed separately.

11. The method of claim 10, wherein the fractions are distilled to a final alcohol content of 95-96% alcohol.

12. The method of claim 2, wherein the soybeans are processed prior to use by a growth stimulator not less than 3 hours before germination.

13. The method of claim 12, wherein the growth stimulator is electro-water activated on a membranous electrolyser with negative redox-potential (−500−900} mV at pH 9.0-11.0.

14. The method of claim 13, wherein the electro-activated water is added in an amount of not less than 50% to the total mass of soybeans.

15. The method of claim 9, wherein dry soy milk or dry cow milk whey is added to the raw spirit of fractions 1, 2 and 3 in the amount of 0.5-5.0 kg per 1000 liters spirit, prior to purification of each fraction.

16. The method of claim 15, wherein each fraction is mixed and maintained for not less than 3 hours prior to filtration.

17. The method of claim 1, wherein soy milk whey is added to the mash in the ratio of no more than 10:1 by mass prior to fermentation.

18. The method of claim 9, wherein the raw spirit of fractions 1, 2 and 3 is warmed to 60-70° C.

19. The method of claim 18, wherein bee's wax, which was previously melted at 60-70° C. is added to the raw spirit of fraction 1, 2, and 3.

20. The method of claim 19, wherein the bee's wax and raw spirit of each fraction, respectively, are mixed for not less than 30 minutes and then cooled to room temperature.

21. The method of claim 19, wherein the bee's wax is removed following hardening of the bee's wax and the raw spirit is filtered.

22. A method of making an aqueous alcohol solution comprising mixing the ethyl alcohol of claim 1 with an electro-activated water/salt solution activated on a membranous electrolyser with a negative redox-potential (−500−900) mV and pH 9.0-11.0, wherein the ethyl alcohol and water/salt solution mixture is 40% alcohol.

23. The method of claim 22, wherein the electro-activated water/salt solution is a mixture of the following salts: NaCl, KCl, CaCl₂, and MgCl₂.

24. The method of claim 23, wherein the salts NaCl, KCl, CaCl₂, and MgCl₂ are used in a ratio of 80:2:2:1, respectively, with the total salt concentration being no more than 10 g/liter.

25. The method of claim 1, wherein the fermented okara is purified prior to distillation.
